(19) United States
(12) Patent Application Publication
(10) Pub. No.: US 2005/0244554 A1
(43) Pub. Date: Nov. 3, 2005

(54) ANIMAL CHEW TOY

(76) Inventor: CHRISTOPHER ALAN WEINBERG, TEMECULA, CA (US)

Correspondence Address: MICHAEL BLAINE BROOKS, P.C., P.O. BOX 1630, SIMI VALLEY, CA, 93062-1630, US

(21) Appl. No.: 11/161,007

(22) Filed: Jul. 19, 2005

Related U.S. Application Data
(63) Continuation-in-part of application No. 10/781,201, filed on Feb. 17, 2004.

(51) Int. Cl. A23G 1/00

(52) U.S. Cl. 426/282

(57) ABSTRACT

Disclosed is a animal chew product and method of making the animal chew product wherein an animal hide is treated, a filling is prepared and the filing is combined with the treated hide and thereafter the product may be shaped and/or pressed, dried and an outer coat of flavoring may be added to the product. The product has an outer casing of rawhide and a filling having poultry liver and/or poultry bone meal.

### CROSS-REFERENCE TO RELATED APPLICATIONS

This application is a continuation-in-part of application Ser. No. 10/781,201 filed Feb. 17, 2004, which claims the benefit of U.S. Provisional Patent Application Ser. No. 60/491,880, to Christopher Alan Weinberg, entitled, “ANIMAL CHEW TOY,” filed Aug. 1, 2003, the disclosures of which, including all attached documents, is hereby incorporated by reference herein, in its entirety, for all purposes.

### FIELD OF THE INVENTION

The present invention relates to animal chews and particularly to animal chew toys having an animal hide enclosing a filling.

### BACKGROUND

Presently, commercial pet chew toys, particularly those for dogs, are designed to exercise the jaw muscles of a pet and through prolonged mastication, work to clean the teeth and gums. For many dogs, these dry and often tasteless products are unappealing, and as a result, are not used or used very little and accordingly are not efficacious as articles to induce and sustain animal interest for jaw muscle exercise and animal teeth cleaning articles.

Chew toys for dogs include those that incorporate a meat and rawhide formulation as part of the manufacturing process. For example, some chew toys are filled rawhide products with meat content. Unfortunately, as the meat content increases, the chew toy serves more as a food delivery system, or pet snack, than as a toy to satisfy the chewing instinct while offering only a minimal ability to clean the teeth and gums. Other chew toys utilize a process whereby a flat, jerked piece of meat is inserted along the seam of the rawhide chew with the jerked meat making the rawhide chew more appealing for dogs to chew and thereby exercise and clean their teeth and gums. Unfortunately, because the jerked meat is not anchored or affixed to the rawhide, when a dog begins to chew on the item, the dog easily removes the jerked meat from the seam of the product and thereafter abandons the rawhide chew casing. There remains a need for a chew toy having a sturdy casing with an appealing filling that remains well anchored throughout the life of the chew toy.

### SUMMARY

The present invention is an animal chew toy that includes an outer casing comprising rawhide and an inner filling comprising a filing such as poultry liver. The rawhide of the outer casing may be the hide of an animal, for example the outer casing may be made of pork hide, cowhide, and combinations thereof. The filing may include poultry liver such as chicken liver and chicken liver meal, poultry bone meal such as chicken bone meal, comminuted pork skin, wheat flour, and combinations thereof.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 is a flowchart of the overall process of the present invention;

FIG. 2A is a top view of a filled expanded rawhide twist, having a filling, in accordance with a preferred embodiment of the present invention;

FIG. 2B is a perspective view of an expanded rawhide twist, having a filling, in accordance with a preferred embodiment of the present invention;

FIG. 3 is a perspective view of a filled natural rawhide twist, in accordance with a preferred embodiment of the present invention;

FIG. 4 is a perspective view of a mesquite-smoked, rawhide twist, having a filling, in accordance with a preferred embodiment of the present invention;

FIG. 5 is a perspective view of a mesquite-smoked, knotted rawhide bone-shaped twist, having a filling, in accordance with a preferred embodiment of the present invention;

FIG. 6A is a top view of a savory-bacon coated, rawhide twist, having a filling, in accordance with a preferred embodiment of the present invention;

FIG. 6B is a perspective view of a savory-bacon coated, rawhide twist, having a filling, in accordance with a preferred embodiment of the present invention;

FIG. 7A is a perspective view of a rawhide pressed bone, having a filling, in accordance with a preferred embodiment of the present invention;

FIG. 7B is an alternate perspective view of a rawhide pressed bone, having a filling, in accordance with a preferred embodiment of the present invention;

FIG. 8A is a top view of rawhide pressed stick, having a filling, in accordance with a preferred embodiment of the present invention;

FIG. 8B is a perspective view of rawhide pressed stick, having a filling, in accordance with a preferred embodiment of the present invention; and

FIG. 9 is a layered cutaway view of the rawhide pressed stick, having a filling, in accordance with a preferred embodiment of the present invention.

### DETAILED DESCRIPTION

The invention, in its several embodiments, is described below together with figures herein referenced and incorporated by reference in this disclosure. The animal chew toy or treat of the present invention includes constituent elements such as a filling enclosing an outer casing, where the outer casing is preferably made of pork hide, bovine rawhide and other animal hides or simulated hides. The invention is manufactured in a variety of shapes, such as rolls, twists, bones, sticks, pressed bones, pressed rolls, pressed twists, ear shapes, chicken wing shapes, and may take on other shapes that can be formed from the pork hide and bovine rawhide and other animal hide and simulated hide materials.

In the several embodiments of the present invention, the center of the chew contains one of several inner fills that are manufactured through a mixing process that typically includes an extrusion process. Some of the preferred embodiments have poultry liver or poultry liver meal fillings some of which may include poultry bone meal. Other preferred embodiments have chicken bone meal fillings. Other filings include a dry meat filling preferably having less than 30% meat, a wheat gluten, mint and parsley filling, and a wheat gluten and dry vegetable filling. The filings of the several embodiments of the present invention are affixed substantially within the middle of the chew and, accordingly, a dog cannot easily remove the inner filling. Thus, the dog is motivated or baited to chew and thereby exercise its teeth and gums on the casing while being attracted to the filling. Because the preferred fillings are blended mixtures of ingredients, they have the capacity of being enhanced with natural flavor in order to increase the product sensory appeal to the dog and with the increased flavor thereby causing the dog to more vigorously chew. Fillings of the present invention may include, in alternative embodiments, one or more nutritional supplements. For example, the fillings may include one or more of the following: a multi-vitamin such as a combination of Vitamins A and C; minerals typically in trace amounts such as iron, phosphorus, and zinc and minerals in larger percentages by weight such as calcium; and one or more omega-3 oils; and a glucosamine-based supplement.

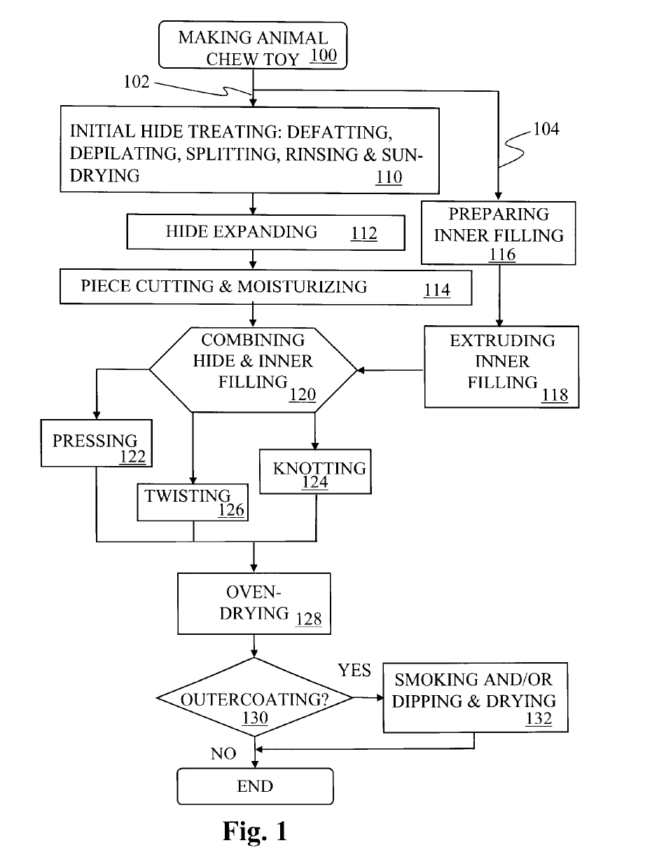

An overview of the process of making the animal chew toy is illustrated in FIG. 1. The process 100 involves two concurrent or roughly parallel sub-process paths: the hide or casing preparation 102 and the inner filling preparation 104. In the inner filling preparation 116, alternative embodiments of the present invention include a rod of extruded, dried products, e.g., meat, poultry, poultry liver, vegetable or wheat-gluten-mint-parsley, poultry bone meal, or combinations thereof, that have been shown to be very appealing to dogs where the rod is highly flavored, and appetizing to the pet, that, as a fill product or filling, is placed in the center of the chew or interposed between layers of the rawhide, during manufacturing. The extrusion process is comprised of a mass containing the constituent ingredients that is ground to a smooth consistency; for example, a preferred consistency is comparable to that of bread dough or paste. The filling as a paste is then forced through a die under pressure, creating one of several shapes including for example flat strips, round sticks and other shapes appropriate for the inner filling of the chew toy embodiments of the present invention. In its several embodiments, this rod is a strip, a plug or a piece. Depending on the desired chew toy product, the filling piece may be shaped in various ways to accommodate the type of product being manufactured.

In the hide preparation sub-process 102, the initial hide treatment includes a de-fatting and depilation treatment 110. Included in this step is the splitting of the hide to obtain successive layers of rawhide materials and the rinsing and sun-drying of the layers of hide. An additional step in the finishing process may in some embodiments be applied to make the hide material thicker 112. This alternative step 112 involves expanding the hide, using a combined solution of fresh water and hydrogen peroxide for a period of time. Preferably, the hydrogen peroxide to water is 20 per cent by volume and the exposure of the hide layer to the solution is approximately four hours.

Depending upon the type of chew being manufactured, the finished hide is cut into various sizes of pieces, strips, or shreds and moisture is added in order to make the product pliable for further processing (step 114). Once an inner filling is prepared (step 116), it is extruded 118 and combined 120 with the hide material. Depending of the shape of the chew, that is, depending on the mode of shaping, there is alternatively a step of pressing 122, twisting 126 or knotting 124. Thereafter, oven-drying 128 is used to finish the product. In some alternative embodiments, if over-coating is desired 130, a smoking and/or dipping and drying step 132 is included to finish the product.

For example, in manufacturing the chew having a twist shape, long strips of pork hide or bovine rawhide are twisted together preferably with a rod of hot or cold extruded meat, poultry, poultry liver, vegetable or wheat-gluten-mint-parsley, poultry bone meal, or combinations thereof, in the middle, to a length of approximately 6 feet and secured on a rack. These racks are then placed in a low temperature oven at approximately 40 degrees centigrade for approximately 3-4 days to dry slowly, typically from the inside out. When fully dry, that is having a moisture content of about 5-7% by weight, the 6-foot length is removed and cut into shorter lengths of from 4 inches up to 10 inches, for example.

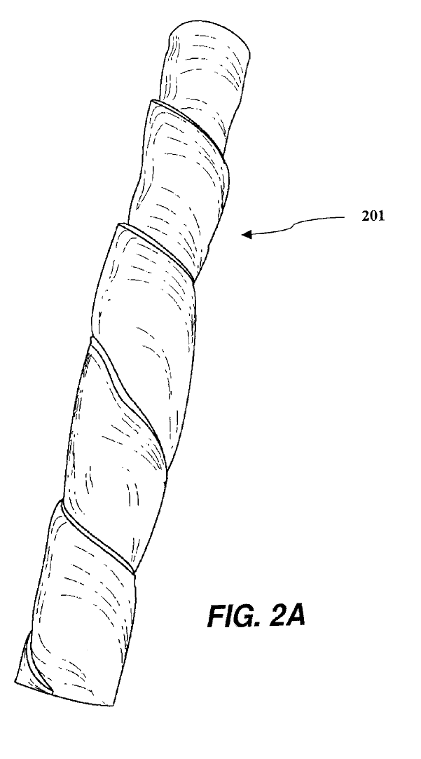

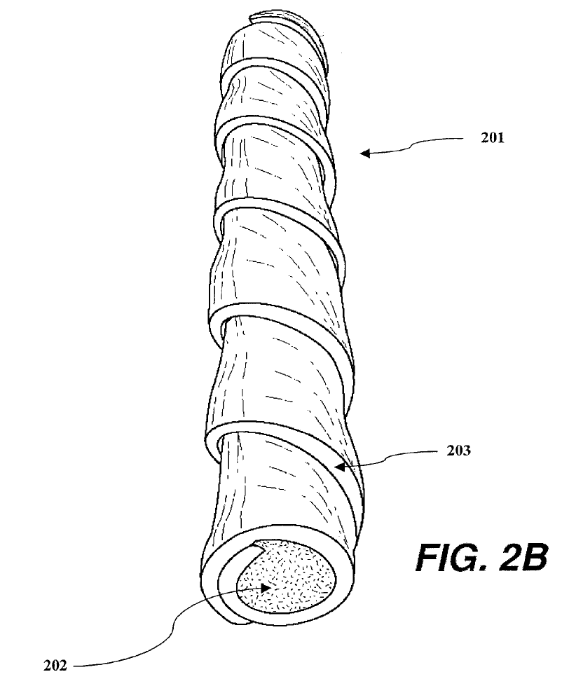

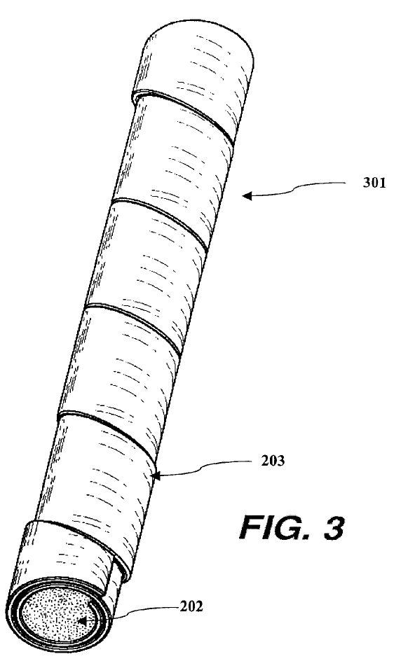

FIG. 2A illustrates a top view of an expanded rawhide twist 201 and FIG. 2B illustrates a perspective view of the expanded rawhide twist 201 illustrating it having a filling 202. The twist is made preferably of a pork or bovine rawhide 203, which is formed into a twist shape. The expanded rawhide twist 201 in this example causes the hide 203 to become thicker than the untreated or “natural” rawhide. The expanded rawhide twist 201 encases a filling 202 which can be hot or cold extruded meat, poultry, poultry liver, vegetable or wheat-gluten-mint-parsley, poultry bone meal, or combinations thereof, for example. Such twists may, as an alternative, not employ the expansion step and accordingly appear more compact as in FIG. 3, where, FIG. 3 illustrates a perspective view of a natural rawhide twist 301 having a filling 202. Like the expanded rawhide, the natural rawhide twist may be made preferably of a pork or bovine rawhide 203, which is formed into a twist shape. As with the expanded hide, the natural rawhide twist encases a filling 202 which can be hot or cold extruded meat, poultry, poultry liver, vegetable or wheat-gluten-mint-parsley, poultry bone meal, or combinations thereof.

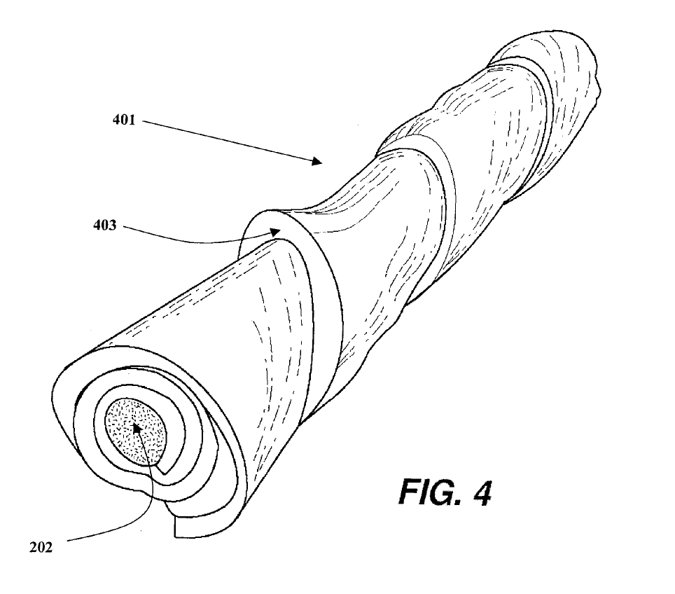

FIG. 4 illustrates a perspective view of a mesquite-smoked, pork hide twist 401 having a filling 202. The twist is made preferably of a mesquite-smoked, pork hide 403, which is formed into a twist shape having more turns and a rolling angle steeper, or more inclined, than those previously illustrated. As is the case with the expanded and natural hides, the twist encases a filling 202 which can be hot or cold extruded meat, poultry, poultry liver, vegetable or wheat-gluten-mint-parsley, poultry bone meal, or combinations thereof.

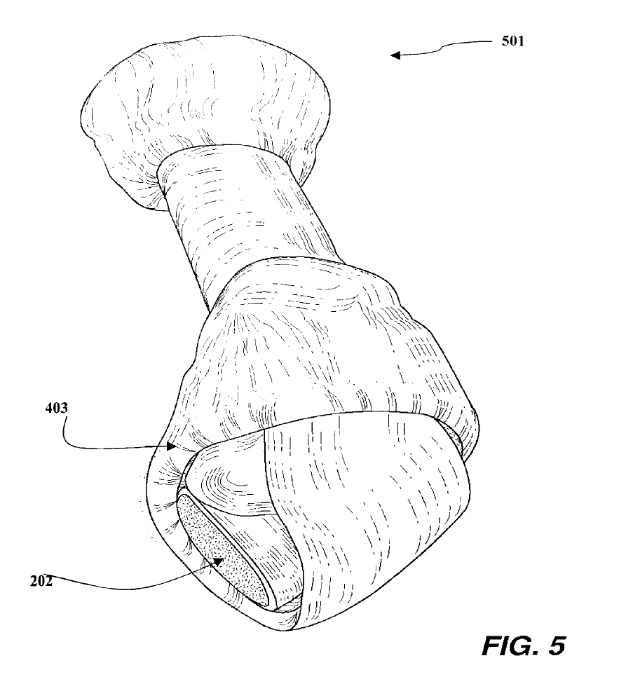

FIG. 5 illustrates a perspective view of a mesquite-smoked, knotted pork hide bone-shaped twist 501 having a filling 202 that is exposed in this example. Preferably, the knot is produced through a hand-tying process or a mechanized equivalent. During this process, a filling 202 is extruded into a long, flat strip or rod. The flat strip is cut to length and placed from end to end, in the middle of the rectangular piece of pork hide or bovine rawhide 403. After placement of the fill strip 202, the hide 403 is folded, length wise and knotted at both ends.

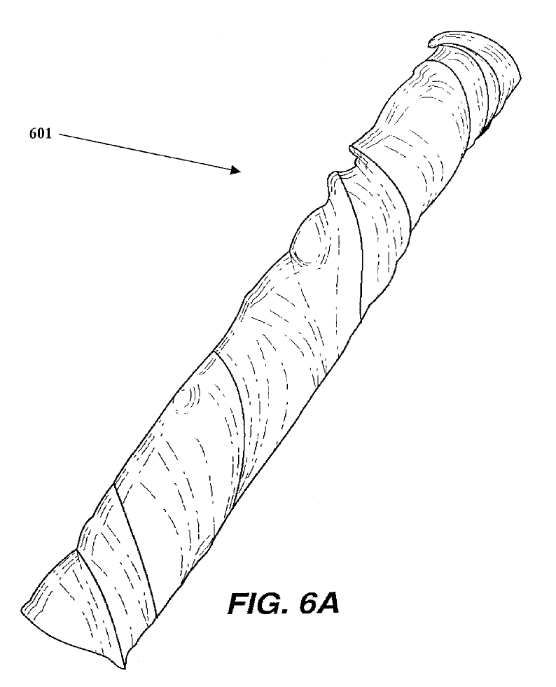

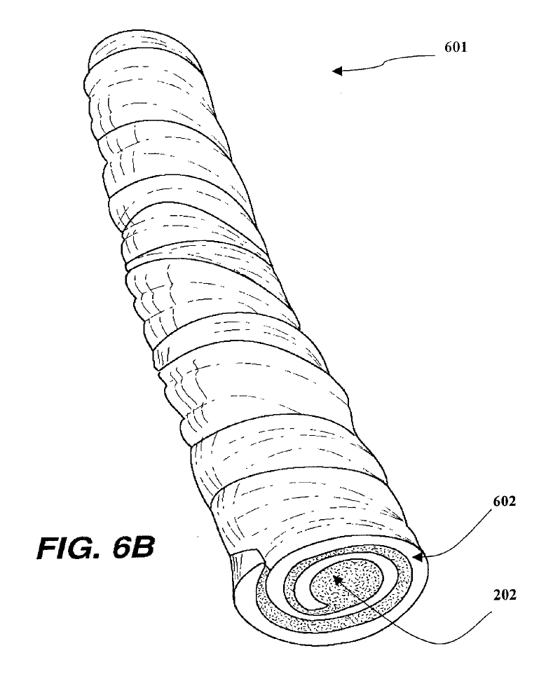

FIG. 6A illustrates a top view of a savory-bacon coated, pork hide twist 601. The shape of the expanded twist is maintained. FIG. 6B illustrates a perspective view of a savory-bacon coated, pork hide twist 601 having a filling 202. The twist is made preferably of a savory-bacon coated, pork hide 602, which is formed into a twist shape. As with the twists without coatings, this twist encases a filling 202 which can be hot or cold extruded meat, poultry, poultry liver, vegetable or wheat-gluten-mint-parsley, poultry bone meal, or combinations thereof.

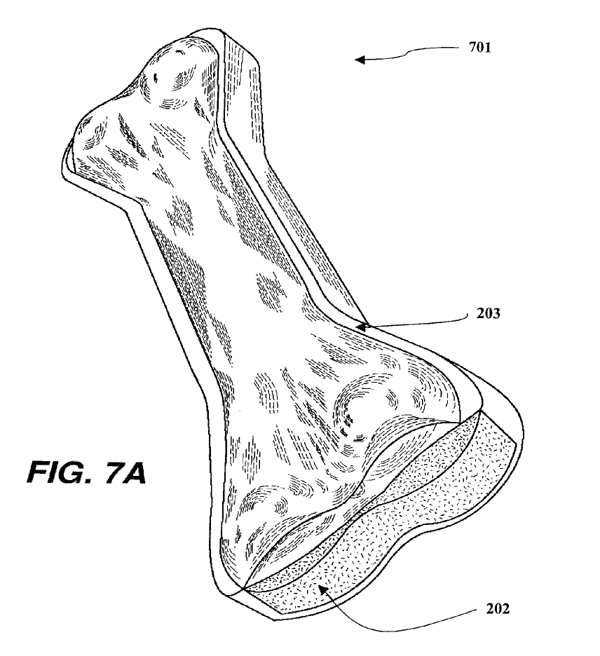

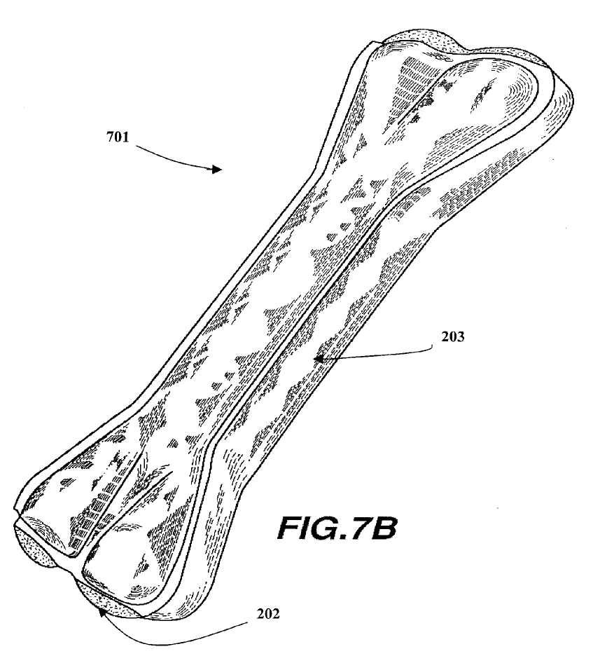

FIG. 7A illustrates a perspective view of a rawhide pressed bone 701 having a filling or plug 202 that is exposed in this example. The bone is made preferably of pork or bovine rawhide and other animal hides or simulated hides that are particularly appealing to dogs 203, which is formed into a bone shape. The rawhide pressed bone 701 encases a filling or plug 202 which can be hot or cold extruded meat, poultry, poultry liver, vegetable or wheat-gluten-mint-parsley, poultry bone meal, or combinations thereof. FIG. 7B illustrates in an alternate perspective view of a rawhide pressed bone 701 having a filling or plug 202. In the manufacture of the pressed bone, the inner plug 202 of hot or cold extruded meat, vegetable, or wheat gluten-mint-parsley is wrapped around the outside by a piece of pork hide or bovine rawhide and other animal hides or simulated hides 203, where the ends of the plug remaining exposed. The wrapped plug is placed in a high-pressure, preferably metal, die press and pressed into the desired shape. This embodied product is also dried in an oven to the necessary moisture level. This process can be used to make pressed shapes other than bones including pressed twists, pressed sticks, pressed rib bones, pressed chicken wings, and various other shapes.

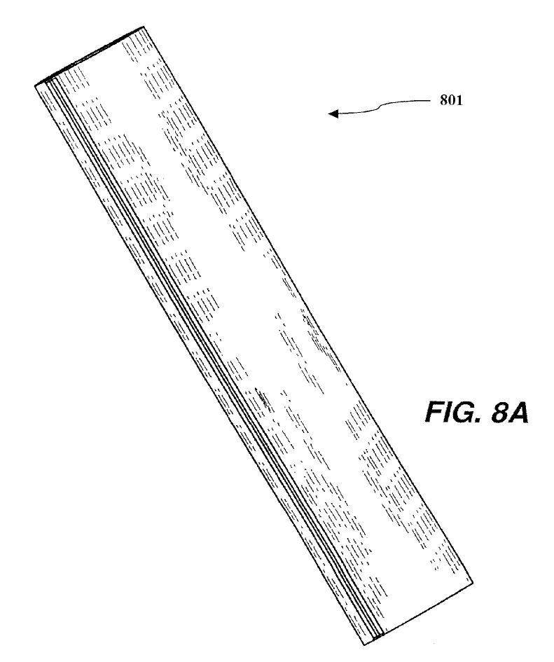

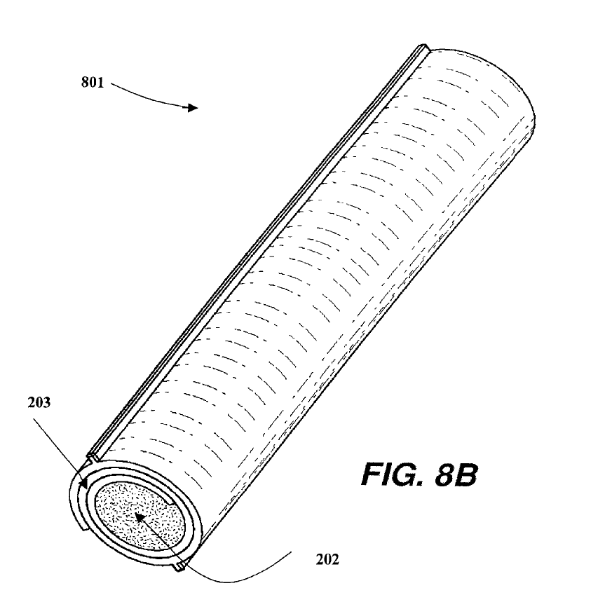

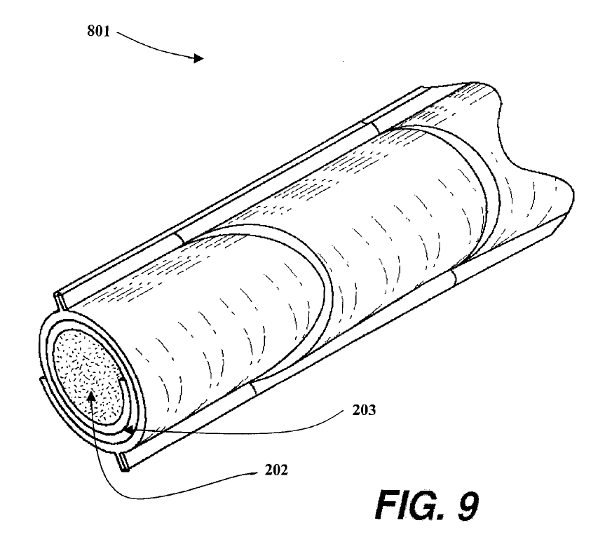

FIG. 8A illustrates a top view of a rawhide pressed stick 801 and FIG. 8B illustrates a perspective view of a rawhide pressed stick 801 having a filling 202. The stick is made preferably of pork or bovine rawhide and other animal hides or simulated hides that are particularly appealing to dogs 203, which is formed into a stick shape. As with other embodiments, the rawhide pressed stick 801 encases a filling 202 which can be hot or cold extruded meat, vegetable or wheat-gluten-mint-parsley. FIG. 9 illustrates a layered cutaway view of a rawhide pressed stick 801 having a filling 202.

Inner Filling

The inner fill 202 of the chew embodiments described is preferably filled with one of the following: a dry meat product, having less than 30% meat; a wheat gluten, mint and parsley product; or a wheat gluten, dry vegetable product.

### EXAMPLE 1

Ingredients and preparation of the dry meat product containing less than 30% by weight meat are illustrated by example as follows in Table I. Other embodiments include poultry striated muscle along with the beef or instead of the beef and the total animal protein for these exemplary embodiments is preferably less than 30% by weight.

TABLE I

| Ingredients | Percentage by weight |
|---|---|
| Beef | 28-30% |
| Wheat Flour | 15-17% |
| Soy Flour | 14-15% |
| Wheat Middlings | 10-12% |
| Corn Syrup | 5-7% |
| Wheat Gluten | 5-7% |
| Corn Starch | 4-6% |
| Sugar | 3-5% |
| Propylene Glycol | 3-5% |
| Salt | Less than 1% |
| Caramel Color | Less than 1% |
| Phosphoric Acid | Less than 1% |
| Animal Fat | Less than 1% |
| Potassium Sorbate | Less than 1% |
| Garlic Powder | Less than 1% |
| Onion Extract | Less than 1% |
| Bone Phosphate | Less than 1% |
| Natural Smoke Flavor | Less than 1% |
| BHA (Used as a preservative) | Less than 1% |

In preparation, the beef is thawed and ground into one-quarter inch pieces. After grinding, the meat is preferably placed in a horizontal bowl cutter and cut into a smooth paste. Upon completion, the beef and all other ingredients are placed in a horizontal mixer and blended, typically until smooth. The mixture is then preferably placed into a hot extrusion machine where the formula is again blended and heated to a temperature of 105 degrees centigrade. The mixture passes through a stainless steel tube containing a corkscrew-shaped stainless steel shaft located inside the stainless steel tube. The stainless steel tube and stainless steel shaft create a sustained pressure behind the mixture, which is forced through a template that produces a flat strip or round stick. The extrusion then passes through an oven and is dried at 85 degrees centigrade for approximately 2 hours until the moisture content of the extrusion is reduced to 24%. The product is then cooled, vacuum packaged, and stored at room temperature.

### EXAMPLE 2

Ingredients and preparation of the wheat gluten, mint and parsley product are illustrated by example as follows in Table II.

TABLE II

| Ingredients | Percentage by weight |
|---|---|
| Gluten | 28-30% |
| Glycerin | 12-14% |
| Rice Flour | 12-14% |
| Sweet Rice Flour | 11-13% |
| Deionized Water | 11-13% |
| Chicken Meal | 8-11% |
| Gelatin | 6-8% |
| Lecithin | Less than 1% |
| Sodium Diacetate | Less than 1% |
| Fennel Seed Powder | Less than 1% |
| Dill Seed Powder | Less than 1% |
| Sodium Tripolyphosphate | Less than 1% |
| Chlorophyll | Less than 1% |
| Peppermint Oil | Less than 1% |
| Parsley Herb Oil | Less than 1% |

The chicken meal is an example of poultry meal for some embodiments and may be replaced by poultry bone meal and, by example, chicken bone meal. In preparation, all of the above ingredients are placed in a horizontal mixer and blended, typically until smooth. The mixture is then placed into the hot extrusion machine where the formula is again blended and heated to a temperature of approximately 105 degrees centigrade. The mixture passes through a stainless steel tube containing a corkscrew-shaped stainless steel shaft located inside the stainless steel tube. The stainless steel tube and stainless steel shaft create a sustained pressure behind the mixture, which is forced through a template that produces a flat strip or round stick. The extrusion then passes through an oven and is dried at approximately 85 degrees Centigrade for approximately two hours, until the moisture content of the extrusion is reduced to approximately 24%. The product is then cooled, vacuum packaged, and stored at room temperature.

### EXAMPLE 3

Ingredients and preparation of the wheat gluten and dry vegetable product are illustrated by example as follows in Table III.

TABLE III

| Ingredients | Percentage by weight |
|---|---|
| Wheat Gluten | 44-46% |
| Glycerin | 22-24% |
| Powdered Dehydrated Vegetables | 19-21% |
| (preferably including carrots, | |
| potatoes, celery, beets, parsley, | |
| watercress, and spinach) | |
| Water, Preferably Deionized | 4-6% |
| Gelatin | 3-5% |
| Lecithin | Less than 1% |
| Sodium Diacetate | Less than 1% |
| Fennel Seed Powder | Less than 1% |
| Dill Seed Powder | Less than 1% |
| Sodium Tripolyphosphate | Less than 1% |

The dry vegetable product is preferably a one or more powdered, dehydrated vegetables typically selected from a group including carrots, potatoes, celery, beets, parsley, watercress, and spinach. Other vegetables may be included for selection depending on the nutritional, flavor and shelf-life of the product desired. In preparation, all of the above ingredients are placed in a horizontal mixer and blended for approximately 10 minutes, typically until smooth. The mixture is then placed into the hot extrusion machine where the formula is again blended and heated to a temperature of approximately 105 degrees centigrade. The mixture passes through a stainless steel tube containing a corkscrew-shaped stainless steel shaft located inside the stainless steel tube. The stainless steel tube and stainless steel shaft create a sustained pressure behind the mixture, which is forced through a template that produces a flat strip or round stick. The extrusion then passes through an oven and is dried at approximately 85 degrees centigrade for approximately 2 hours, until the moisture content of the extrusion is reduced to approximately 24%. The product is then cooled, vacuum packaged, and stored at room temperature.

### EXAMPLE 4

An embodiment having a poultry liver exemplary filling has as an ingredient, chicken liver, with other exemplary ingredients illustrated by example as follows in Table IV.

TABLE IV

| Ingredients | Percentage by weight |
|---|---|
| Pork skin fiber | 0-40% |
| Chicken liver | 5-40% |
| Chicken bone meal | 0-30% |
| Wheat Flour | 0-50% |
| Water | 5-15% |
| Corn Syrup | 2-20% |
| Glycerin | 2-20% |
| Phosphoric Acid | 0-2% |
| Lecithin | 0-2% |
| Potassium Sorbate | 0-2% |
| BHT (exemplary antioxidant) | 0-2% |
| Natural vegetable coloring | 0-2% |

Pork skin fiber is typically derived from comminuted pork hide. Chicken liver meal may used in place of chicken liver. Poultry bone meal may used in place of chicken bone meal. Preferably, poultry bone meal is the dried chicken carcass comprised of the torso and neck portions of a chicken, for example, and the remainder of its skeleton, after the mechanical removal, or de-boning, of substantially all and as much of the skeletal flesh, muscles and the heart of the chicken and its leg and wing portions as practicable within manufacturing limitations, is ground into a meal. In some embodiments that include poultry bone meal, the poultry liver is replaced by poultry liver flavoring or other flavorings.

In preparation, all of the above ingredients are placed in a horizontal mixer and blended, typically until smooth. The mixture passes through a stainless steel tube containing a corkscrew-shaped stainless steel shaft located inside the stainless steel tube. The stainless steel tube and stainless steel shaft create a sustained pressure behind the mixture, which is forced through a template that produces a flat strip or round stick. The extrusion then passes through an oven and is dried at approximately 85 degrees Centigrade for approximately two hours, until the moisture content of the extrusion is reduced to approximately 24%. The product is then cooled, vacuum packaged, and stored at room temperature.

Coatings

Further processing optionally includes utilizing a natural mesquite smoking process, as well as flavor coating the entire product. Additionally, any of the above chews can be dipped in liquid gluten derived from pork hide or bovine rawhide 203. The liquid gluten enhances the durability of the chew by providing an additional, hard outer layer.

Some of the embodiments of the present invention include a savory smoked bacon flavor (FIG. 6B) coating made of the following ingredients in Table V.

TABLE V

| Ingredients | Percentage by weight |
|---|---|
| Beef | 49-51% |
| Natural Molasses | 17-19% |
| Liquid Smoke | 11-3% |
| Soy Protein | 7-9% |
| Wheat Gluten | 5-6% |
| Propylene Glycol | 5-6% |
| Beef Marrow | Less than 1% |
| Brewers Yeast | Less than 1% |

In preparation, fresh beef or thawed frozen beef is ground into one-quarter inch pieces. The meat is blended in a horizontal mixer with the natural molasses, liquid smoke, soy protein, wheat gluten, propylene glycol, beef marrow and brewers yeast. After mixing the formulation is then passed through an emulsifier for a finer degree of grinding. This fine ground emulsion is placed in a reactor vessel, where it is stirred and heated to approximately 70 degrees centigrade for approximately one hour. After cooling the mixture is again emulsified to a finer degree and returned to the reactor vessel, where it is stirred and heated to approximately 85 degrees centigrade for approximately one hour. The pH of the mixture is adjusted to approximately 3.0. Finally the product is cooled, packaged in sterile drums, and stored at room temperature.

Scope of the Invention

An animal chew toy is described above. One of ordinary skill in the art recognizes that various details of the invention may be changed without departing from its scope. Furthermore, the foregoing description of the preferred embodiments of the invention and best mode for practicing the invention are provided for the purpose of illustration and not for the purpose of limitation. Many alterations and modifications may be made by those having ordinary skill in the art without departing from the spirit and scope of the invention. The words used in this specification to describe the invention in its several embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself. The definitions of the words or elements of the following claims are, therefore, defined in this specification to include not only the combination of elements which are literally set forth, but all equivalent structure, material or acts for performing substantially the same function in substantially the same way to obtain substantially the same result. In addition to the equivalents of the claimed elements, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. Therefore, it must be understood that the illustrated preferred and alternative embodiments have been set forth only for the purposes of example and that it should not be taken as limiting the invention as defined by the following claims.

1. An animal chew toy comprising:
an outer casing comprising rawhide and
an inner filling comprising poultry liver.

2. The animal chew toy of claim 1 wherein the rawhide comprises pork hide.

3. The animal chew toy of claim 1 wherein the rawhide comprises cowhide.

4. The animal chew toy of claim 1 wherein the poultry liver comprises chicken liver.

5. The animal chew toy of claim 4 wherein the chicken liver is chicken liver meal.

6. The animal chew toy of claim 4 wherein the inner filling further comprises chicken bone meal.

7. The animal chew toy of claim 4 wherein the inner filling further comprises wheat flour.

8. The animal chew toy of claim 4 wherein the inner filling further comprises comminuted pork skin.

9. An animal chew toy comprising:
a outer casing comprising rawhide and
an inner filling comprising poultry bone meal.

10. The animal chew toy of claim 9 wherein the rawhide comprises pork hide.

11. The animal chew toy of claim 9 wherein the rawhide comprises cowhide.

12. The animal chew toy of claim 9 wherein the poultry bone meal comprises chicken bone meal.

13. The animal chew toy of claim 9 wherein the inner filling further comprises poultry liver.

14. The animal chew toy of claim 13 wherein the poultry liver comprises chicken liver.

15. The animal chew toy of claim 13 wherein the inner filling further comprises poultry liver meal.

16. The animal chew toy of claim 13 wherein the inner filling further comprises chicken liver meal.

17. The animal chew toy of claim 13 wherein the inner filling further comprises wheat flour.

18. The animal chew toy of claim 13 wherein the inner filling further comprises comminuted pork skin.
